(19) United States
(12) Patent Application Publication
(10) Pub. No.: US 2017/0342356 A1
(43) Pub. Date: Nov. 30, 2017

(54) Multi-compartment Water-Soluble Unit Dose Article Comprising A Bleach Catalyst

(71) Applicant: The Procter & Gamble Company, Cincinnati, OH (US)

(72) Inventors: Neil Joseph Lant, Newcastle upon Tyne (GB); Stefano Scialla, Strombeek-Bever (BE); Linsey Sarah Fuller, Newcastle upon Tyne (GB); Robby Renilde Francois Keuleers, Lippelo (Sint Amands) (BE); Alan Thomas Brooker, Newcastle upon Tyne (GB)

(21) Appl. No.: 15/596,307

(22) Filed: May 16, 2017

(30) Foreign Application Priority Data
May 26, 2016 (EP) 16171593.3

(51) Int. Cl. C11D 17/04; C11D 10/04; C11D 3/39; C11D 3/37; C11D 3/08; C11D 3/20; C11D 3/10; C11D 11/00; C11D 3/22; C11D 1/22; C11D 1/66

(52) U.S. Cl. CPC C11D 17/045; C11D 11/0017; C11D 10/042; C11D 3/3942; C11D 3/392; C11D 3/3917; C11D 3/3753; C11D 3/225; C11D 3/08; C11D 3/2065; C11D 3/2044; C11D 3/10; C11D 1/66; C11D 1/22

(57) ABSTRACT

A water-soluble unit dose article including a water-soluble film and a first compartment and a second compartment, where the first compartment includes a powder composition, where the powder composition includes an acyl hydrazone bleach catalyst; and where the second compartment includes a liquid composition, where the liquid composition includes between about 10% and about 25% by weight of the liquid composition of a non-aqueous solvent system; where the non-aqueous solvent system includes a polyol and a monoalcohol.

### FIELD OF THE INVENTION

The present disclosure relates to water-soluble unit dose articles comprising a bleach catalyst and methods of their use.

### BACKGROUND OF THE INVENTION

Water-soluble unit dose articles are liked by consumers as being convenient and efficient to use. They comprise a single unit dose of a cleaning or treatment composition that can be added to water to create a suitable wash liquor.

Formulation of bleaching ingredients into the cleaning or treatment composition provides beneficial cleaning benefits. However, such water-soluble unit dose articles can suffer from premature activation of the bleach ingredients. This can detrimentally affect the stability of the water-soluble unit dose article by causing premature rupture of the unit dose article due to bleaching species damaging the water-soluble film and/or the bleach species damaging other formulation ingredients. Overall this negatively affects the consumer wash experience.

Therefore, the remains a need in the art for a water-soluble unit dose article comprising a bleach ingredient wherein the instances of premature bleach activation are minimized.

It was surprisingly found that a water-soluble unit dose article according to the present invention overcame this technical problem. The specific combination of a unit dose article comprising a liquid composition and a powder composition, wherein the powder composition comprised a specific bleach catalyst and the liquid composition comprised a specific solvent system overcame this technical problem.

### SUMMARY OF THE INVENTION

The present disclosure relates to a water-soluble unit dose article comprising a water-soluble film and a first compartment and a second compartment, wherein the first compartment comprises a powder composition, wherein said powder composition comprises an acyl hydrazone bleach catalyst; and wherein the second compartment comprises a liquid composition, wherein said liquid composition comprises between 10% and 25% by weight of the liquid composition of a non-aqueous solvent system; wherein the non-aqueous solvent system comprises a polyol and a monoalcohol.

The present disclosure also relates to a process of washing fabrics comprising the steps of diluting a water-soluble unit dose article according to the present disclosure in sufficient water to dilute the powder and liquid compositions between 300 and 800 fold to form a wash liquor and contacting fabrics to be washed with said wash liquor.

### DETAILED DESCRIPTION OF THE INVENTION

### Water-Soluble Unit Dose Article

The water-soluble unit dose article comprises a water-soluble film and a first compartment and a second compartment. The water-soluble film is described in more detail below. The first compartment comprises a powder composition and the second compartment comprises a liquid composition. The powder and liquid compositions are described in more detail below.

The water-soluble unit dose article comprises at least one water-soluble film shaped such that the unit-dose article comprises at least two internal compartments surrounded by the water-soluble film. The at least two compartments comprise the powder and liquid compositions respectively. The water-soluble film is sealed such that the compositions do not leak out of the compartments during storage. However, upon addition of the water-soluble unit dose article to water, the water-soluble film dissolves and releases the contents of the internal compartments into the wash liquor.

The compartment should be understood as meaning a closed internal space within the unit dose article, which holds the composition. The unit dose article is manufactured such that the water-soluble film completely surrounds the compositions and in doing so defines the compartment in which the composition resides. The unit dose article may comprise two films. A first film may be shaped to comprise one or more open compartments into which the one of the compositions is added. A second film is then laid over the first film in such an orientation as to close the opening of the compartment. The first and second films are then sealed together along a seal region. The film is described in more detail below.

The unit dose article may comprise more than two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

One of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

The first and second compartments maybe positioned side-by-side to one another, preferably wherein the first and second compartments are separated by a bridge region. The ‘bridge region’ is comprised of the film material and separates the two compartments from one another but allows the first compartment to stay attached to the second compartment and vice versa.

Preferably, the first and second compartments are positioned side-by-side to one another, preferably wherein the first and second compartments are separated by a bridge region.

The water-soluble unit dose article may comprise between 10 ml and 20 ml, preferably between 12 ml and 18 ml of the liquid composition. The water-soluble unit dose article may comprise between 5 g and 15 g, preferably between 7 g and 12 g of the powder composition.

### Powder Composition

The powder composition comprises an acyl hydrazone bleach catalyst. The bleach catalyst is described in more detail below.

The powder composition may have an average particle size diameter of between 100 microns and 1500 microns, preferably between 100 microns and 1000 microns, more preferably between 100 microns and 750 microns. Those skilled in the art will be aware of standard techniques to measure particle size.

The powder composition may comprise between 0.001% and 1%, preferably between 0.01% and 0.75%, more preferably between 0.1% and 0.5% by weight of the composition of the acyl hydrazone bleach catalyst.

The powder composition may comprise a source of hydrogen peroxide, wherein the hydrogen peroxide source is preferably selected from alkali metal perborates, alkali metal percarbonates, urea perhydrates, peroxycarboxylic acids, alkali metal persulfates, alkali metal peroxydisulfates, Caroates (e.g., potassium peroxymonosulfate), diacyl peroxides, tetraacyl diperoxides or a mixture thereof, more preferably percarbonate.

The powder composition may comprise between 5% and 35%, preferably between 6% and 30%, more preferably between 7% and 25% by weight of the powder composition of the hydrogen peroxide source.

The powder composition may comprise TAED, soap, brightener, carboxymethylcellulose, enzymes, soil release polymer, surfactant, citrate, HEDP, 8-hydroxyquinoline sulphonic acid, dihydroxyterephthalic acid derivatives, alkali metal carbonates, alkali metal bicarbonates, alkali metal silicates, alkali metal sulphates or a mixture thereof.

### Liquid Composition

The second compartment comprises a liquid composition. The liquid laundry detergent composition of the present invention overall is liquid in nature. That is to say, even though it comprises a solid phase dispersed within a liquid phase, the composition has the nature of a liquid rather than a solid or granular composition. In relation to the laundry detergent composition of the present invention, the term ‘liquid’ encompasses forms such as dispersions, gels, pastes and the like. The liquid composition may also include gases in suitably subdivided form. However, the liquid composition excludes forms which are non-liquid overall, such as tablets or granules.

The liquid composition comprises between 10% and 25% by weight of the liquid composition of a non-aqueous solvent system. The non-aqueous solvent system is described in more detail below.

The liquid composition may comprise linear alkylbenzene sulphonate, alkoxylated alkyl sulphate, fatty alcohol ethoxylate, oxo-synthesised non-ionic surfactant, brightener, chelant, soil release polymer, ethoxylated polyethyleneimine, enzymes, monoethanolamine, triethanolamine or a mixture thereof.

### Non-Aqueous Solvent System

The liquid composition comprises a non-aqueous solvent system. The non-aqueous solvent system comprises a polyol and a monoalcohol.

Preferably, the weight ratio of polyol to monoalcohol is between 2:1 and 6:1, more preferably between 3:1 and 5:1.

The polyol may be selected from glycerol, propylene glycol, trimethylene glycol, sorbitol or a mixture thereof, preferably the polyol is selected from glycerol, propylene glycol or a mixture thereof.

Preferably, the polyol is selected from glycerol and propylene glycol and preferably wherein the weight ratio of glycerol to propylene glycol is between 3:1 and 1:3, preferably between 2:1 and 1:2.

The monoalcohol is selected from methanol, ethanol, propan-2-ol, butan-1-ol, or a mixture thereof, preferably ethanol.

The liquid composition comprises between 10% and 25%, preferably between 12% and 20% by weight of the liquid composition of a non-aqueous solvent system.

### Acyl Hydrazone Bleach Catalyst

The power composition comprises an acyl hydrazone bleach catalyst. Preferably, the powder composition comprises between 0.001% and 1%, more preferably between 0.002% and 0.5%, most preferably between 0.003% and 0.1% by weight of the composition of the acyl hydrazone bleach catalyst.

Preferably, the acyl hydrazone bleach catalyst has the formula I;

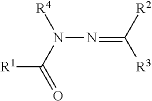

wherein, R¹ is selected from the groups comprising CF₃, C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl, C₃₋₁₂ cycloheteroalkyl or a mixture thereof;
R² and R³ are independently selected from the group comprising hydrogen, substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, heteroaryl or a mixture thereof;
or R² and R³ are linked to form a substituted 5-, 6-, 7-, 8- or 9-membered ring that optionally comprises heteroatoms;
and R⁴ is selected from the groups comprising hydrogen, C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, substituted phenyl, naphthyl, heteroaryl or a mixture thereof.

More preferably, the acyl hydrazone bleach catalyst is 4-(2-(2-((2-hydroxyphenylmethyl)methylene)-hydrazinyl)-2-oxoethyl)-4-methylchloride having the formula II;

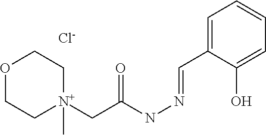 [SMILES: C[N+]1(CC(=O)N/N=C/c2ccccc2O)CCOCC1 ; [Cl-]]

Acyl hydrazone bleach catalysts boost the bleaching action of peroxidic bleaching agents, without unduly damaging the substrate to be cleaned, for example the fabric. The peroxidic bleaching agents are preferably H₂O₂ or substances that release H₂O₂ in water, including in particular alkali metal perborates, alkali metal percarbonates and urea perhydrates; however, they may be also possibly employed combined with peroxycarboxylic acids, such as diperoxydecanedicarboxylic acid or phthalimido peroxycaproic acid, with other acids or acidic salts, such as alkali metal persulfates or alkali metal peroxydisulfates or Caroates, or with diacyl peroxides or tetraacyl diperoxides.

Acyl hydrazones may be processed into the detergent in the form of a granulate. The granulate may be a two-layer coated granulate comprising;
a) a core pellet comprising 5 to 40% by weight based on the weight of the total granule of an acyl hydrazone of formula (I) and 1-10% by weight based on the weight of the total granule of water and/or water soluble binder which is selected from the group consisting of polyvinyl alcohols, polyvinylpyrrolidones, polyacrylates, cellulose derivatives, carbohydrates, polyethyleneglycols and mixtures thereof;
b) 0.1% to 25% by weight based on the weight of the total granule of a subcoating comprising a polymer mixture of hydoxypropylmethylcellulose (HPMC) and methylcellulose (MC) in a ratio by weight of from 2:1 to 8:1;
c) 1 to 25% by weight based on the weight of the total granule of a topcoating comprising a fatty acid selected from nonadecanoic acid, stearic acid, palmitic acid, myristic acid and mixtures thereof; and
d) other components
   the sum of components (a) to (d) adding to 100%.

Preferably, the acyl hydrazone bleach catalyst is comprised within a granule, wherein preferably the granule comprises between 5% and 40% by weight of the granule of the acyl hydrazone bleach catalyst.

### Water-Soluble Film

The unit dose article comprises a water-soluble film. Preferably, the water-soluble film comprises a polyvinylalcohol.

The film of the present invention is soluble or dispersible in water. The water-soluble film preferably has a thickness of from 20 to 150 micron, preferably 35 to 125 micron, even more preferably 50 to 110 micron.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the film material. This can be beneficial to control the mechanical and/or dissolution properties of the compartments or unit dose article, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films are those supplied by Monosol under the trade references M8630, M8900, M8779, M8310.

Of the total PVA resin content in the film described herein, the PVA resin can comprise 30 to 85 wt % of the first PVA polymer, or 45 to 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000 s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

### Method of Making

Those skilled in the art will be aware of standard methods and techniques to make the liquid and powder compositions.

Those skilled in the art will be aware of standard techniques to make the unit dose article. Standard forming processes including but not limited to thermoforming and vacuum forming techniques may be used.

### Method of Washing

One aspect of the present invention is a process of washing fabrics comprising the steps of diluting a water-soluble unit dose article in sufficient water to dilute the powder and liquid compositions between 300 and 800 fold to form a wash liquor and contacting fabrics to be washed with said wash liquor.

The unit dose article of the present invention can be added to a wash liquor to which laundry is already present, or to which laundry is added. It may be used in an automatic washing machine operation and added directly to the drum or to the dispenser drawer. It may be used in combination with other laundry detergent compositions such as fabric softeners or stain removers.

Preferably the wash liquor has a pH of between 6.5 and 12, more preferably between 7 and 9.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

A unit dose article comprising a water-soluble PVOH film, preferably M8630 film commercially available from Monosol and between 7 g and 10 g of a free-flowing powder and between 12 g and 18 g of a liquid comprising;

| | Wt % by weight | Wt % by weight |
|---|---|---|
| | of the powder | of liquid |
| Ingredient | composition | composition |
| Percarbonate | 25%-35% | |
| TAED | 7%-12% | |
| 4-(2-(2-((2- | 0.001%-1% | |
| hydroxyphenylmethyl)methylene)- | | |
| hydrazinyl)-2-oxoethyl)-4- | | |
| methylchloride | | |
| Soap | 2%-5% | 5%-15% |
| Brightener 49 | 0.01%-2% | |
| Carboxymethylcellulose | 5%-12% | |
| Sodium carbonate | 2%-6% | |
| Sodium bicarbonate | 6%-14% | |
| Sodium silicate | 6%-12% | |
| Sulphate | 6%-12% | |
| Linear alkylbenezene sulphonate | | 20%-30% |
| Fatty alcohol ethoxylate non-ionic | | 20%-30% |
| surfactant | | |
| Monoethanol/triethanolamine | | 5%-15% |
| 1,2-Propanediol | | 12%-16% |
| Glycerin | | 2.5%-7.5% |
| Ethanol | | 0.5%-3.5% |
| Water | 1%-4% | 5%-12% |
| Enzymes, colourants, perfumes | Up to 100% | Up to 100% |
| and other common laundry | | |
| detergent ingredients | | |

What is claimed is:

1. A water-soluble unit dose article comprising a water-soluble film and a first compartment and a second compartment,
wherein the first compartment comprises a powder composition, wherein said powder composition comprises an acyl hydrazone bleach catalyst; and
wherein the second compartment comprises a liquid composition, wherein said liquid composition comprises between about 10% and about 25% by weight of the liquid composition of a non-aqueous solvent system;
wherein the non-aqueous solvent system comprises a polyol and a monoalcohol.

2. The water-soluble unit dose article according to claim 1 wherein the weight ratio of polyol to monoalcohol is between about 2:1 and about 6:1.

3. The water-soluble unit dose article according to claim 2 wherein the weight ratio of polyol to monoalcohol is between about 3:1 and 5:1.

4. The water-soluble unit dose article according to claim 1 wherein the polyol is selected from glycerol, propylene glycol, trimethylene glycol, sorbitol, and a mixture thereof.

5. The water-soluble unit dose article according to claim 4 wherein the polyol comprises glycerol and propylene glycol, and wherein the weight ratio of glycerol to propylene glycol is between about 3:1 and about 1:3.

6. The water-soluble unit dose article according to claim 1 wherein the acyl hydrazone bleach catalyst has the formula I: 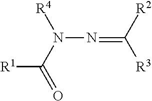
wherein, R¹ is selected from the groups comprising CF₃, C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl, C₃₋₁₂ cycloheteroalkyl or a mixture thereof;
R² and R³ are independently selected from the group comprising hydrogen, substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, heteroaryl or a mixture thereof;
or R² and R³ are linked to form a substituted 5-, 6-, 7-, 8- or 9-membered ring that optionally comprises heteroatoms;
and R⁴ is selected from the groups comprising hydrogen, C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, substituted phenyl, naphthyl, heteroaryl or a mixture thereof.

7. The water-soluble unit dose article according to claim 6 wherein the acyl hydrazone bleach catalyst is 4-(2-(2-((2-hydroxyphenylmethyl)methylene)-hydrazinyl)-2-oxoethyl)-4-methylchloride having the formula II;

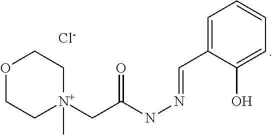 [SMILES: C[N+]1(CC(=O)N/N=C/c2ccccc2O)CCOCC1 ; [Cl-]]

8. The water-soluble unit dose article according to claim 1 wherein the powder composition comprises between about 0.001% and about 1%, by weight of the composition, of the acyl hydrazone bleach catalyst.

9. The water-soluble unit dose article according to claim 8 wherein the powder composition comprises between about 0.01% and about 0.75%, by weight of the composition, of the acyl hydrazone bleach catalyst.

10. The water-soluble unit dose article according to claim 1 wherein the water-soluble unit dose article comprises between about 10 ml and about 20 ml of the liquid composition.

11. The water-soluble unit dose article according to claim 1 wherein the water-soluble unit dose article comprises between about 5 g and about 15 g of the powder composition.

12. The water-soluble unit dose article according to claim 1 wherein the liquid composition comprises linear alkylbenzene sulphonate, alkoxylated alkyl sulphate, fatty alcohol ethoxylate, oxo-synthesised non-ionic surfactant, brightener, chelant, soil release polymer, ethoxylated polyethyleneimine, enzymes, monoethanolamine, triethanolamine or a mixture thereof.

13. The water-soluble unit dose article according to claim 1 wherein the powder composition comprises a source of hydrogen peroxide.

14. The water-soluble unit dose article according to claim 13 wherein the source of hydrogen peroxide is selected from alkali metal perborates, alkali metal percarbonates, urea perhydrates, peroxycarboxylic acids, alkali metal persulfates, alkali metal peroxydisulfates, Caroats (potassium monopersulfate), diacyl peroxides, tetraacyl diperoxides, or a mixture thereof.

15. The water-soluble unit dose article according to claim 13 wherein the powder composition comprises between about 5% and about 35%, by weight of the powder composition, of the hydrogen peroxide source.

16. The water-soluble unit dose article according to claim 1 wherein the powder composition comprises TAED, soap, brightener, carboxymethylcellulose, enzymes, soil release polymer, surfactant, citrate, HEDP, 8-hydroxyquinoline sulphonic acid, dihydroxyterephthalic acid derivatives, alkali metal carbonates, alkali metal bicarbonates, alkali metal silicates, alkali metal sulphates, or a mixture thereof.

17. The water-soluble unit dose article according to claim 1 wherein the water-soluble film comprises a polyvinylalcohol.

18. The water-soluble unit dose article according to claim 1, wherein the first and second compartments are positioned side-by-side to one another.

19. The water-soluble unit dose article according to claim 1, wherein the first and second compartments are separated by a bridge region.

20. A process of washing fabrics comprising the steps of
diluting a water-soluble unit dose article according to claim 1 in sufficient water to dilute the powder and liquid compositions between about 300-fold and about 800-fold to form a wash liquor, and
contacting fabrics to be washed with said wash liquor.
